(19) United States
(12) Patent Application Publication
(10) Pub. No.: US 2002/0120840 A1
(43) Pub. Date: Aug. 29, 2002

(54) Configurable PKI architecture

(75) Inventors: Krishna Kishore Yellepeddy, Austin, TX (US); Lok Yan Leung, Austin, TX (US); Anthony Joseph Nadalin, Austin, TX (US)

Correspondence Address: Law Office of Joseph R Burwell, P O Box 28022, Austin, TX, 78755-8022, US

(73) Assignee: International Business Machines Corporation

(21) Appl. No.: 09/738,240

(22) Filed: Dec. 15, 2000

(51) Int. Cl. G06F 15/16; H04L 9/00

(52) U.S. Cl. 713/156

(57) ABSTRACT

A architecture for implementing PKI technology is described. Individual processing modules responsive to events are initiated. These individual software module building blocks, or “beans” are placed and linked together in an assembly line-like manner. Each bean is responsive to particular events and does one particular action in the scheme. For example, individual beans are responsive to different format PKI requests from a network, and in turn generate an event corresponding to that request. The event is broadcast to other beans that take the event and perform some other operation in the defined process. Other beans include certificate generators, publishers, manipulators, broadcasters to output streams, and also beans that can act as boolean branches. When strung together, the beans form a cohesive PKI schema. The ability to place beans in the flow and remove them allows great flexibility in developing PKI implementations. Typically, the beans are written in a environment and platform neutral manner, such as the Java® programming language. Not only may the beans be used to build both defined and customized PKI schemas easily, but the schemas may be spread out among many computing devices. Additionally, the use of Java® allows for fast implementation of additions to PKI schemas. Therefore, as new certificate standards, new formats, or new dissemination methods are developed, appropriate beans may be written to implement these and dropped into place seamlessly.

### RELATED APPLICATIONS

The following co-pending applications are all assigned to the assignee of the invention and are incorporated herein by reference:

1. U.S. Ser. No. ______, entitled “Dynamic Modular PKI Architecture” filed on in the names of; and

2. U.S. Ser. No. ______, entitled “Dynamic PKI Architecture” filed on in the names of

### BACKGROUND

1. Field of the Invention

The present invention relates to an improved data processing system, and, in particular, to a method and apparatus for multi-computer data transfer. Still more particularly, the present invention provides a method and apparatus for computer to computer user and/or data authentication.

2. Description of Related Art

Public key infrastructure (PKI) refers to a technology defining an infrastructure that implements and delivers pervasive security structures using public key cryptography concepts and techniques. The proliferation of PKI services has mushroomed in light of the demand of users to exchange secure data or verify users and/or associated data over interconnected networks, such as the Internet.

These demands are causing end entities (EEs) to request certificates from either registration authorities (RAs) or directly from certification authorities (CAs). These certificates allow a third party to verify the identity and/or other information associated or connected with such end entity. This information is passed through interconnected networks, such as the Internet, and typically involves the use of public/private key pairings in order to facilitate such verifications.

PKI may be involved in entity to entity transactional situations, wherein one entity wants to verify and authenticate the identity of the other entity involved in the transaction. Or, such PKI infrastructure may be used for the passage of digital certificates that allow others access to computer systems and/or other resources such as software.

CAs may not actually perform all functions connected with issuing a certificate. In this case, an end entity may apply for registration for a certificate with a RA. The RA then conducts a number of checks on the end entity to determine whether the end-entity may receive a certificate, or determine any number of parameters in which the certificate may operate. These parameters may be associated with a “trust” level, a length of time that the certificate is valid for, or for any number of formal or user defined parameters.

The RA may then transmit any and/or all data and verification parameters to one or more CAs. Thus, the registration authority is typically preoccupied with the actual verification and preliminary registration of an EE request for certification, while the CA is more involved with the specifics regarding the actual issuance of digital certificates and/or revocations of any such certificates. However, the roles of CAs and RAs may become increasingly blurred as different entities perform different tasks. Or, such functionality may merge depending on the scope of a specific mission task to be implemented.

With the proliferation of PKI ideas, standards, and technology, much software has been written to enable the different aspects of such PKI methodology. Specific software exists for each player in the PKI scheme.

As such, the RA typically uses particular software designed solely to perform its particular PKI functionality. And the CA typically uses particular software designed solely to perform its particular PKI functionality.

However, many software systems tailored for these specific functions and/or users are typically monolithic in nature. For example, many vendors provide software that performs functions associated with the role of a CA. Or, software exists that performs functions associated with the role of an RA.

Typically, such software systems are very large in scope, both in terms of size and resources. The lines of code associated with such monolithic software projects may run into the tens of thousands. This monolithic strategy typically hampers any CA or RA that wishes to implement a specific procedure for the particular scheme that they have employed.

Additionally, as the roles of RA and CA blur, such monolithic programs fail to integrate the functionalities associated with each. Correspondingly, the monolithic scale of such software inhibits the rapid integration of functionality that may be split across each entity in the PKI process, including end entities, registration authorities, and certification authorities.

As well as can be imagined, some typical monolithic programs can be hard to maintain. Any changes in usage or characteristics of goal-specific or global implementations Of PKI may entail a massive reworking of the legacy software.

The invention may be implemented in a platform independent manner. This may be accomplished through the use of Java® software, or other product that allows easy integration of software to multiple platforms and operating systems.

These characteristics inhibit the development and usage of many typical PKI implementations. Many other problems and disadvantages of the prior art will become apparent to one skilled in the art after comparing such prior art with the present invention as described herein.

### SUMMARY OF THE INVENTION

The current invention relates to a PKI architecture. The infrastructure is composed of functional building blocks of software, or “beans”. The beans are typically written in a fashion where they are linked together through propagating events. In one embodiment they are written in an object oriented code, such as Java®. Additionally, the Java® environment, or similar type language systems, allow for the immediate implementation of the beans across a wide variety of computing systems and operate in a system independent manner.

Further, Java®, or its like, allows for the quick insertion and/or implementation of the codebase. As such, the beans may be readily implemented in an already operating environment, allowing for great flexibility in implementing or modifying already existent PKI systems.

Metaphorically, the beans act as the workers, distribution points, and pipelines in a PKI factory. Additional beans act as filters. Beans can perform many functions, and perform their roles based on a hierarchical event system.

Due to the building block architecture described, many widely ranging PKI components or systems may be designed and/or implemented. CA systems may be implemented, as well as RA systems. Due to the inherent flexibility and ease of operation, these functions may be distributed across machines, or may be combined. When combined, a designer may construct any number of levels of combination or repetition. New publishing steps may be added, new protocols may be supported, and a wide gamut of testing and manipulative functionalities may be performed. Additional input and output streams may be added, as well as different formatting schemes.

Typically, the beans perform one function and either generate events, consume events, or propagate events. The propagation may entail altered or unaltered events.

As such, the beans offer a highly robust, adaptable architecture under which PKI entities may construct or modify a wide range of actions of a particular PKI scheme while minimizing the effort in recalibrating it. Other aspects, advantages and novel features of the present invention will become apparent from the detailed description Of the invention when considered in conjunction with the accompanying drawings.

### BRIEF DESCRIPTION OF THE DRAWINGS

FIG. 1 is a schematic diagram of a typical distributed data processing system.

FIG. 2 is a block diagram depicting a typical manner in which an individual obtains a digital certificate.

FIG. 3 is a functional block diagram of how the beans of the invention may be implemented in the handling of a PKI request for a certificate authority.

FIG. 4 is a block diagram of a structure of a requesting authority built according to the invention.

FIG. 5 is a block diagram of how the various client and server beans of the invention allow interconnectivity among the various entities across networks.

FIG. 6 is a block diagram detailing a manner in which the invention may be adapted to provide functional expansion of preexisting monolithic systems.

FIG. 7 is an inheritance diagram showing the particular inheritance structure of events in a particular embodiment of the invention.

FIG. 8 is an inheritance diagram of the methods employed by the beans and using the events noted in FIG. 7.

FIG. 9 is a block diagram further detailing the queue-like structure of the invention as implemented in one embodiment of the invention

### DETAILED DESCRIPTION OF THE INVENTION

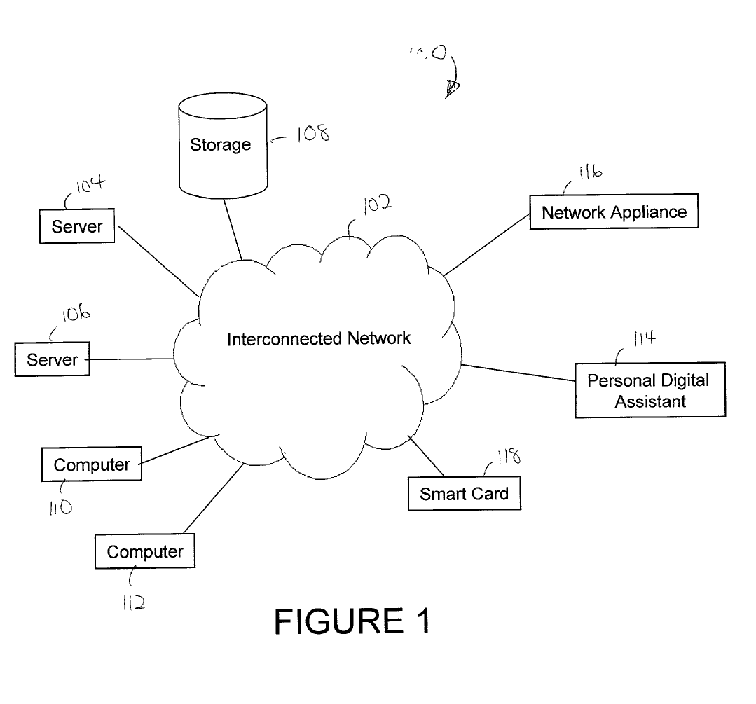

FIG. 1 is a schematic diagram of a typical network of data processing systems. Any of the data processing systems of FIG. 1 may implement the present invention. A distributed data processing system 100 contains a network 102. The network 102 provides communications link between all the various devices and computers connected within the distributed processing system 100. The network 102 may include permanent connections, such as wire or fiber optic cables, or other types of connections such as wireless, satellite, or infrared network technology.

The network 102 may operate under a number of different operating schemes. Communications may flow between the associated components of the distributed processing system 15100 under various protocols, including TCP/IP. The network 102 may also be indicative of several interconnected networks, such as the Internet.

The network 102 connects a server 104 and a server 106. Additionally, a storage unit 108 is also connected to the network 102, thus allowing the servers 104 and 106 to communicate with and store data to and from the storage unit 108. Other typical clients on the network 102 may be stand-alone computers 110 and 112.

Additional computing components connected to the network 10 may include a personal digital assistant 114 and a remote network appliance 116. Additionally, an individual user may carry a so-called “smart card” 118. The smart card may contain sufficient data and/or processing capabilities to allow connection to and communication with other components of the distributed data processing system 100.

It should also be noted that the distributed data processing system may also include numerous different types of networks. Any one of, or any combination of, for example, an intranet, a local area network (LAN), a wide area network (WAN), or an aggregation of units may be connected to each other in a fashion.

If using the network in a secure fashion, the network may be local to the individual clients. Or such secure network may be implemented upon a public network using various security protocols, thus creating a virtual secure network (VSN) molded from the public network infrastructure. Also, the present invention may be implemented on a variety of hardware and software platforms, as described above.

Digital certificates support public key cryptography in which each party involved in a communication or transaction has a pair of keys, called the public key and the private key. Each party's public key is published while the private key is kept secret. Public keys are numbers associated with a particular entity and are intended to be known to everyone who needs to have trusted interactions with that entity. Private keys are numbers that are supposed to be known only to a particular entity, i.e. kept secret. In a typical public key cryptographic system, a private key corresponds to exactly one public key.

Within a public key cryptography system, since all communications involve only public keys and no private key is ever transmitted or shared, confidential messages can be generated using only public information and can be decrypted using only a private key that is in the sole possession of the intended recipient. Furthermore, public key cryptography can be used for authentication, i.e. digital signatures, as well as for privacy, i.e. encryption.

Encryption is the transformation of data into a form unreadable by anyone without a secret decryption key; encryption ensures privacy by keeping the content of the information hidden from anyone for whom it is not intended, even those who can see the encrypted data. Authentication is a process whereby the receiver of a digital message can be confident of the identity of the sender and/or the integrity of the message.

For example, when a sender encrypts a message, the public key of the receiver is used to transform the data within the original message into the contents of the encrypted message. A sender uses a public key to encrypt data, and the receiver uses a private key to decrypt the encrypted message.

When authenticating data, data can be signed by computing a digital signature from the data and the private key of the signer. Once the data is digitally signed, it can be stored with the identity of the signer and the signature that proves that the data originated from the signer. A signer uses a private key to sign data, and a receiver uses the public key to verify the signature. The present invention is directed to a form of authentication using digital certificates; some encryption is also performed during the processing within the present invention.

A certificate is a digital document that vouches for the identity and key ownership of entities, such as an individual, a computer system, a specific server running on that system, etc. Certificates are issued by certificate authorities. A certificate authority (CA) is an entity, usually a trusted third party to a transaction, that is trusted to sign or issue certificates for other people or entities. The CA usually has some kind of legal responsibilities for its vouching of the binding between a public key and its owner that allow one to trust the entity that signed a certificate. There are many such certificate authorities, such as VeriSign, Entrust, etc. These authorities are responsible for verifying the identity and key ownership of an entity when issuing the certificate.

If a certificate authority issues a certificate for an entity, the entity must provide a public key and some information about the entity. A software tool, such as specially equipped Web browsers, may digitally sign this information and send it to the certificate authority. The certificate authority might be a company like VeriSign that provides trusted third-party certificate authority services. The certificate authority will then generate the certificate and return it. The certificate may contain other information, such as dates during which the certificate is valid and a serial number. One part of the value provided by a certificate authority is to serve as a neutral and trusted introduction service, based in part on their verification requirements, which are openly published in their Certification Service Practices (CSP).

Typically, after the CA has received a request for a new digital certificate, which contains the requesting entity's public key, the CA signs the requesting entity's public key with the CA's private key and places the signed public key within the digital certificate. Anyone who receives the digital certificate during a transaction or communication can then use the public key of the CA to verify the signed public key within the certificate. The intention is that an entity's certificate verifies that the entity owns a particular public key.

The X.509 standard is one of many standards that defines the information within a certificate and describes the data format of that information. The ‘version” field indicates the X.509 version of the certificate format with provision for future versions of the standard. This identifies which version of the X.509 standard applies to this certificate, which affects what information can be specified in it. Thus far, three versions are defined. Version I of the X.509 standard for public key certificates was ratified in 1988. The version 2 standard, ratified in 1993, contained only minor enhancements to the version I standard. Version 3, defined in 1996, allows for flexible extensions to certificates in which certificates can be extended in a standardized and generic fashion to include additional information.

In addition to the traditional fields in public key certificates, i.e. those defined in versions I and 2 of X.509, version 3 comprises extensions referred to as “standard extensions”. The term “‘standard extensions refers to the fact that the version 3 of the X.509 standard defines some broadly applicable extensions to the version 2 certificate. However, certificates are not constrained to only the standard extensions, and anyone can register an extension with the appropriate authorities. The extension mechanism itself is completely generic.

Other aspects of certificate processing are also standardized. The Certificate Request Message Format (RFC 2511) specifies a format recommended for use whenever a relying party is requesting a certificate from a CA. Certificate Management Protocols have also been promulgated for transferring certificates. More information about the X.509 public key infrastructure (PKIX) can be obtained from the Internet Engineering Task Force (IETF) at www.ietf.org.

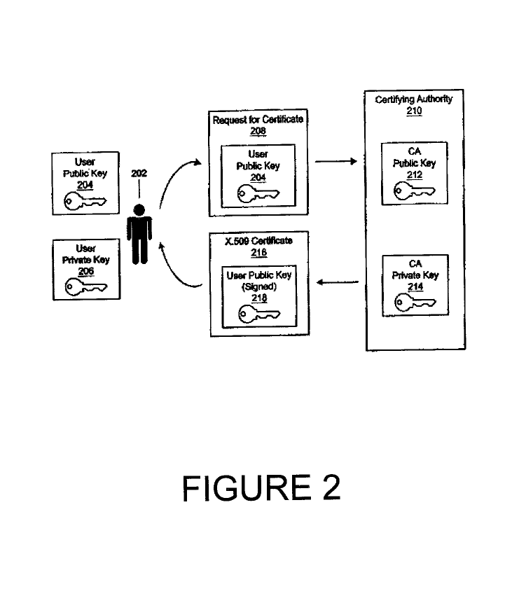

FIG. 2 is a block diagram depicting a typical manner in which an individual obtains a digital certificate. User 202, operating on some type of client computer, has previously obtained or generated a public/private key pair, e.g., user public key 204 and user private key 206. User 202 generates a request for certificate 208 containing user public key 204 and sends the request to certifying authority 210, which is in possession of CA public key 212 and CA private key 214. Certifying authority 210 verifies the identity of user 202 in some manner and generates X.509 digital certificate 216 containing signed user public key 216 that was signed with CA private key 214. User 202 receives newly generated digital certificate 216, and user 202 may then publish digital certificate 216 as necessary to engage in trusted transactions or trusted communications. An entity that receives digital certificate 216 may verify the signature of the CA by using CA public key 212, which is published and available to the verifying, entity.

It should be noted that various functional aspects of the CA may be split off into an RA. The RA or multiple RAs may in turn communicate the processed requests to the CA for certificate generation. Or, a single RA may communicate information to multiple CAs, or any combination thereof.

In overview, the present invention envisions a system wherein the monolithic nature of the RA and CA software systems are replaced through the use of individualized building block software modules. These building blocks can be assembled to perform both the RA and/or CA functionality, or any combination of steps as defined by a designer to implement many different PKI schemas. Additional building blocks may be defined as new functionalities and/or standards are realized within the PKI realm.

In the schema of the invention, each building block performs a simple operation on a request and in turn passes either that request or a new request to one or more next building blocks. As such, the assembly of PKI implementations can be configured in many different ways. The building block concept allows for multiple distribution points where products (events or requests) can be sent to one or multiple different lines of processing. The efforts of assembling any particular process flow are greatly reduced due to the building block nature as envisioned by the invention.

Furthermore, the building blocks may be readily and adaptively configured to perform all levels of RA and CA functionality. Or, the building blocks may be configured to perform various user-specified functionalities within the scope of a PKI scheme.

In one example of the invention, the building blocks are made of single unitary building blocks written in Java®. Thus, each Java® unit, or bean, performs a simple operation on an incoming request and passes its product to the next bean that it is “wired” to. This results in a lightweight, highly flexible, and efficient implementation that can be used to enable PKI schemes that perform a great range of functionality.

As such, a flexible solution that permits applications to integrate the degree of PKI functionality that they desire may be readily implemented. Additionally, when requirements change in an already existing PKI schema, different beans may be used, or different pathways may be constructed between certain beans. This allows for fast modification, customization, and development of specified functionality and flow.

Furthermore, a specific PKI solution may be built from the ground up. For example, one application may need a simple CA that is able to issue certificates and manage the life cycle of these certificates. Another application used by the same entity may also issue certificates in bulk and have support for multiple applications and/or identification procedures. As such, a readily adaptable and lightweight system is described herein for the implementation of any such PKI technology.

This lightweight, flexible, and highly configurable implementation of core components of PKI may be used to provide PKI enabled applications ranging from operating systems to smart card management systems. Correspondingly, these applications may run on a range of platforms; from PCs to mainframes to any low computing devices such as network appliances and so-called “smart cards” to multi-processor based computing devices, such as an RS-6000 workstation running an AIX operating system and containing one or more microprocessors.

In the schema envisioned in the invention, each building block, or “bean”, can do one of many things in response to a request. A bean may: 1) reject a request; 2) satisfy a request, but does not propagate any request; 3) modify and propagate a request; 4) propagate a request, unmodified, with a side effect; 5) just propagate a request with no action; or 6) get a request and propagate a different type of request.

Additionally, the beans may be implemented in a queue-like structure. As such, a request eventually propagates to an end-event bean. At this end-event bean, the request is propagated back through all the previous beans in the form of a return event. This process is repeated until the initial requesting bean is notified of the determination of the initial request. As such, each path of the process is by definition a simple path with one entrance and one exit.

The beans may implement functionality (or perform no function, as the case may be) as the request is propagated forward in the queue, or they may implement completely different functionality (or non-functionality) in the reverse flow direction.

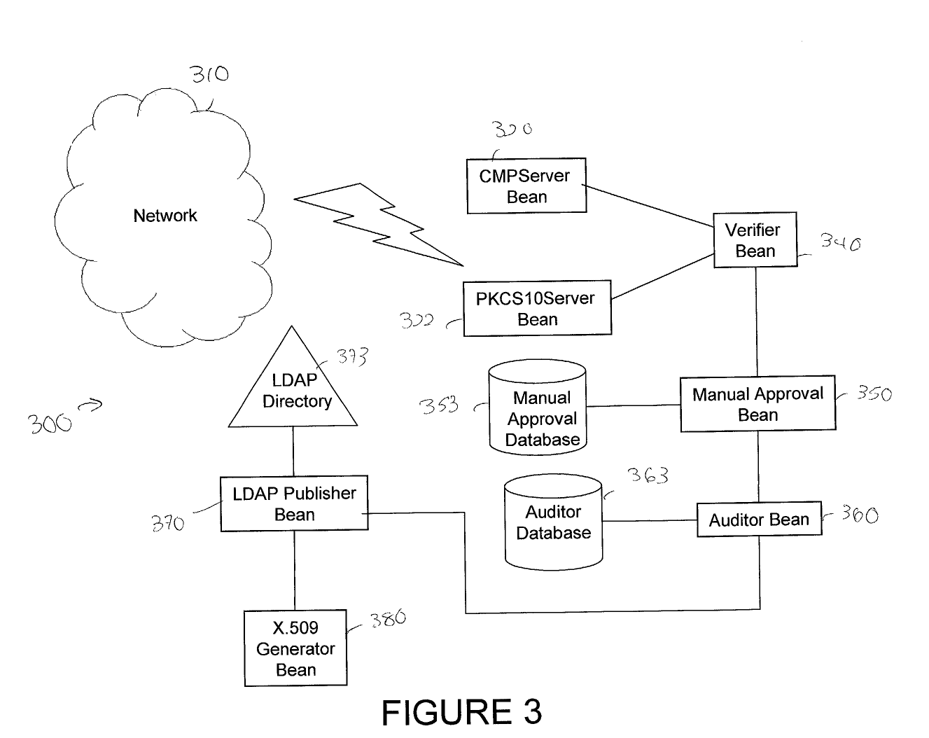

FIG. 3 is a functional block diagram of how the beans of the invention may be implemented in the handling of a PKI request for a certificate authority. A request reaches the PKI system 300 through a connection to a network 310. A Certificate Management Protocol (CMP) server bean 320 receives a CMP request from the network 310. The CMP formatter bean formats the CMP request into a specific request to be sent to the remainder of the system 300.

Likewise, if the request from the network 300 is in the form of a Public Key Cryptography Standard #10 (PKCS10) format, a PKCS10 server bean 312 fields such a request and formats this type of request for transmittal to the remainder of the system 300.

In either case, the first request for the certificate is sent to a verifier 340. The verifier 340 may perform any Of a number type of functions on the request, such as any internal verification of the request, or any types of pre-defined verification of any other external values.

The request is then sent to another bean 350, a manual approval bean. This manual approval bean 350 can blindly send the request to a database 353, in which requests for certificates are automatically stored. Or, the manual approval bean 350 may filter such requests based upon any internal or external criteria. For example, if certain parameters in the request event do not meet certain thresholds, the request may be diverted to the database 353 for later manual approval.

Should the request clear the manual approval bean 350, the request is then directed to an auditor bean 360. The auditor bean oversees the maintenance of an audit database 363. The auditor bean 360 may immediately log incoming requests to the audit database 363, or may wait until the request passes back from the terminus to do so. In this case, the auditor bean 360 is specifically constructed to oversee the audit database 363, and maintain the database 363 upon the request and/or the parameters associated with the particular certificate authority (CA).

After clearing the auditor bean 360, the request may then be sent to a Lightweight Directory Access Protocol (LDAP) publisher bean 370. This LDAP publisher bean 370 publishes any specific parameters associated with such a request to an LDAP directory structure 373. Again, this may take place as the request winds its way through the PKI request system 300 an initial time. Or the publishing of the request in the LDAP directory 373 may take place in the return path of the request after reaching the terminus bean.

It should be noted that such an LDAP publisher is not specific to the invention, but other output or dissemination methods may be employed. For example, instead of basing dissemination of the certificate upon an LDAP directory structure, other repositories may include an X.500 directory system agent, Online Certificate Status Protocol (OCSP) responders, domain name system (DNS) (with certificate and certificate revocation information supported in accordance with RFC 2383), web servers (that may contain certificates and certificate revocation information in accordance with RFC2383, which can be retrieved as hypertext transfer protocol (HTTP)), file transfer protocol (FTP)-based servers (that may contain certificates and certificate revocation information in accordance with RFC 2383), or other types of databases and accompanying protocols (that may contain certificates and certificate revocation information, and that have well-defined management and access practices).

Returning now to our exemplary system, the request now reaches an X.509 generator bean 330. This bean 330 generates the digital certificate based upon the x.509 specification that defines digital certificates containing signed user public keys.

It should be noted that other types of keys and/or generators may be employed at this step if other formats are specified. For example, the X.509 generator may be replaced with any form of digital certificate generator. Other alternative certificate generators may include Simple Public Key Infrastucture (SPKI) public key certificate format, PGPT, or Secure Electronic Transaction (SET) specifications. Or the generator bean may be one that generates a CRL.

It should be noted that the concept in which each bean is separate and fully functional unto itself allows for the interchanging of beans and/or multi-threading of the processes. The request may be propagated to single beans on independent machines or on the same machine. Or, the request may be propagated to multiple beans on the same or different computing devices. As noted before, the propagation could be a unitary broadcast to a single bean, or multicasting the request to many beans.

As such, the verifier bean 340 may send a request at the same time to the manual approval bean 350, the auditor bean 360, and the LDAP publisher bean 370. Instead of the single thread shown, the verifier bean could multicast the request to the aforementioned beans. It should also be noted that the recipient beans may exist on the same machine as the broadcasting bean, or on different computing devices. This allows for efficiencies to be generated in such machine multi-threading.

Also, each bean may operate on multiple requests at once. As such, the beans themselves may be thought of as allowing the system to multi-task as a whole.

Additionally, the independent nature of the beans allows for steps to be interchanged quite easily. For example, any of the beans 350, 360 or 370 may be interchanged, as well as any additional beans introduced anywhere in the process flow.

The two-way nature of the beans allows for further adaptability. In this case, for example, the generator bean 380 receives a request from the publisher bean 370. Upon the generation of a certificate by the generation bean 380, the request may be sent back to the publisher bean 370. Only upon the successful return of the request from the generation bean 380 will be publisher bean 370 publish the results of the successful generation of the certificate in the LDAP directory structure 373.

It should be also clear that this diagram should be illustrative that various functionalities and processing paths may be readily defined in the scope of the invention. As such, a dynamic and flexible system for implementing PKI architectures is shown in the course of defining a building-block approach to the implementation. It should be clear that the system of beans affords the ability to quickly and efficiently design, build, and modify any segment of the PKI, including RA and CA functionalities.

Additionally, this building block approach allows the construction of multiple input as well as output paths. This concept not only allows for the efficient design and implementation of hybrid RA and CA functionality, but allows for multiple RA and CA systems, or combinations of functionality thereof, to be implemented in a single instantiation.

In one embodiment, three types of beans are defined in the architecture. Source beans produce and propagate events and are usually active, meaning that they have their own thread.

Pipe beans consume and propagate events. These include distribution beans, filter beans, and other types of pipeline beans.

Sink beans consume events, and do not propagate events. Such sink beans can include certificate generation beans typically contained at the end of the request structure.

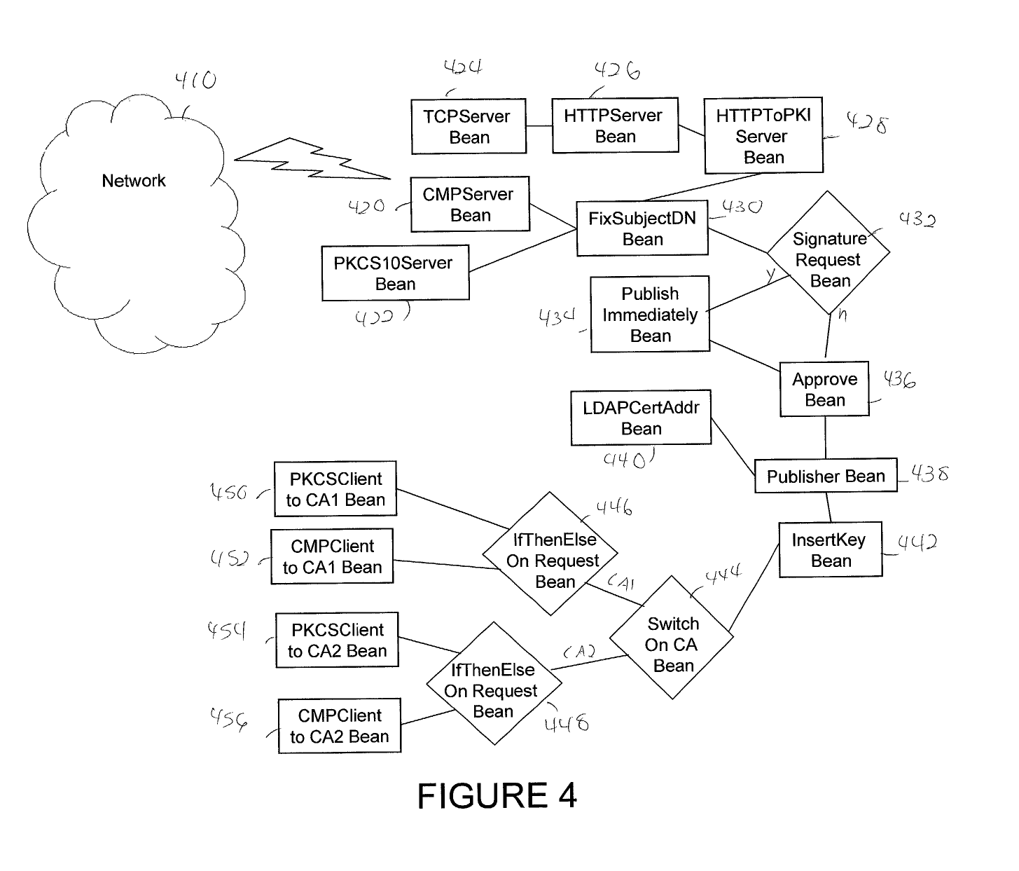

FIG. 4 is a block diagram of a structure of an RA built according to the invention. This FIG. 4 should not only re-emphasize the ability of the architecture to implement singular RA and CA systems in an efficient and adaptable manner, but that the architecture is highly adaptable. As such, hybrid systems with multiple inputs, outputs, publishers, and certificate generators may be efficiently designed and developed.

A request to the system 400 may come in on a network 410 through any number of server beans, including a CMP server bean 420, or a PKCS server bean 422.

If the request comes through a HTTP based request, the TCP server bean 424 performs a preliminary processing of the incoming request and passes it to the HTTP server bean 426, which in turn passes the request to the HTTPTOPKI bean 428. At this stage, the HTTP request is ready for further processing by the system 300.

At this stage, the incoming requests, no matter the source, is directed to the FixSubjectDN bean 430. This bean 430 sets the relative distinguished name (RDN) in the correct order.

The request is then forwarded to a switch bean 432, which determines if the received request is a signature request. If so, the request is sent to the PublishImmediately bean 434. The PublishImmediately bean 434 unconditionally marks requests as requiring immediate publication.

Next, the request is forwarded to an Approve bean 436. The Approve bean 436 approves all the individual elements of the request. Various methods of approval may be implemented within such Approve bean 436. The functionality and the parameters compared within the Approve bean 436 may be completely configurable by the operator. Such attributes for approval may be the time that the certificate is requested for, the type of certificate or level of “trust” wished by the requester, or a test of the Subject Distinguished Name, to name just a few.

The Publisher bean 438 receives the request in turn, and in turn communicates it to the LDAPCertAdder bean 440. This bean 440 adds the appropriate entry and/or information to an associated LDAP directory. In this case, the request is ignored as the request is directed to the certificate generator, described below.

As the return reply event is processed by the LDAPCertAdder bean 440 on the “return flow”, the LDAPCertAdder bean 440 performs the publishing function associated with it. However, this is not to say that all publisher beans operate in the “reverse” rather than the “forward” flow. In fact, depending upon the application, either flow model may be used.

The incoming request, at this point, is directed to the InsertKey bean 442. In the InsertKey bean 442, the appropriate key is inserted into the request. This inserted key may be any key necessary for the full processing of the request. For example, the key implemented may be one of the public key/private key keys generated, as described above. Or, the key may be one described under a certificate revocation list (CRL) scheme. Or, any other key may be used that is defined in a PKI implementation, either currently defined or to be defined in the future.

The resulting request is then directed to a switch bean 444 that directs the output to an appropriate CA. This switch bean 444 allows the RA to direct requests to many different CAs.

As a final step in this example, the request is selectively directed to a particular path or bean from a selection of beans. This takes place in an IfThenElse bean 25448.

In this case, an appropriate output formatter bean is chosen. At the appropriate output bean, the request may be directed to a multitude of CAs in a multitude of formats. In this case, the outputs of the client beans 450, 452, 454, and 456 may be thought of as the progenitors of the requests coming into the system of FIG. 3.

In this building block manner, requests may be generated and acted upon. Additionally, requests may be checked, approved based on some predefined criteria, redirected based upon such criteria, published to databases, and manipulated to extract or insert various parameters as defined in the structures themselves.

Additionally, full functionality of PKI may be achieved, including generating requests for certificates, approving requests, publishing activities including those activities associated with issued, pending, and revoked lists, testing parameters in requests and certificates, manipulating parameters in certificates, to name a few.

Listed below are several exemplary types of beans along with details of the functionality associated therewith:

| TYPE | FUNCTION |
|---|---|
| Approver | Approve individual elements |
| | of a request. |
| Auditor | Audit requests, replies,and |
| | exceptions. |
| CertGen | Generate and sign a |
| | certificate, includes |
| | generators for all defined |
| | and specific certificates. |
| Distributors | Send request to a differerent |
| | bean based on a filter or set |
| | of filters, such as boolean |
| | expressions. |
| Filters | Allow requests to pass when |
| | they comply with certain |
| | criteria. |
| DB and table managers | Manage persistent information |
| | through manipulation of a |
| | database or the tables |
| | included thereof. |
| NameConstraintChecker | Check if a subject DN is |
| | under a given suffix. |
| Publisher | Publishes certificates |
| | somewhere. |
| Inserters | Insert something in a |
| | request. |
| KeyStore | Store the certificate reply |
| | in a key store. |
| Clients and Servers | Used to connect processes via |
| | defined formats. |

Of course, this is not a fixed set of beans. In fact, the architecture allows for numerous types of beans providing widely diverse functional aspects related to PKI.

In particular, the Client and Server beans make the architecture readily adaptable to dynamic environments. Server and Client beans read a request from an input stream and convert that request to an event to be propagated through the system. Conversely, they must also take an event and write the event to an output stream. Should new standards or formats be introduced, a new Client or Server bean may be implemented allowing other preexisting PKI schemas to readily adapt to such new standards or formats, including the underlying communications protocols or standards.

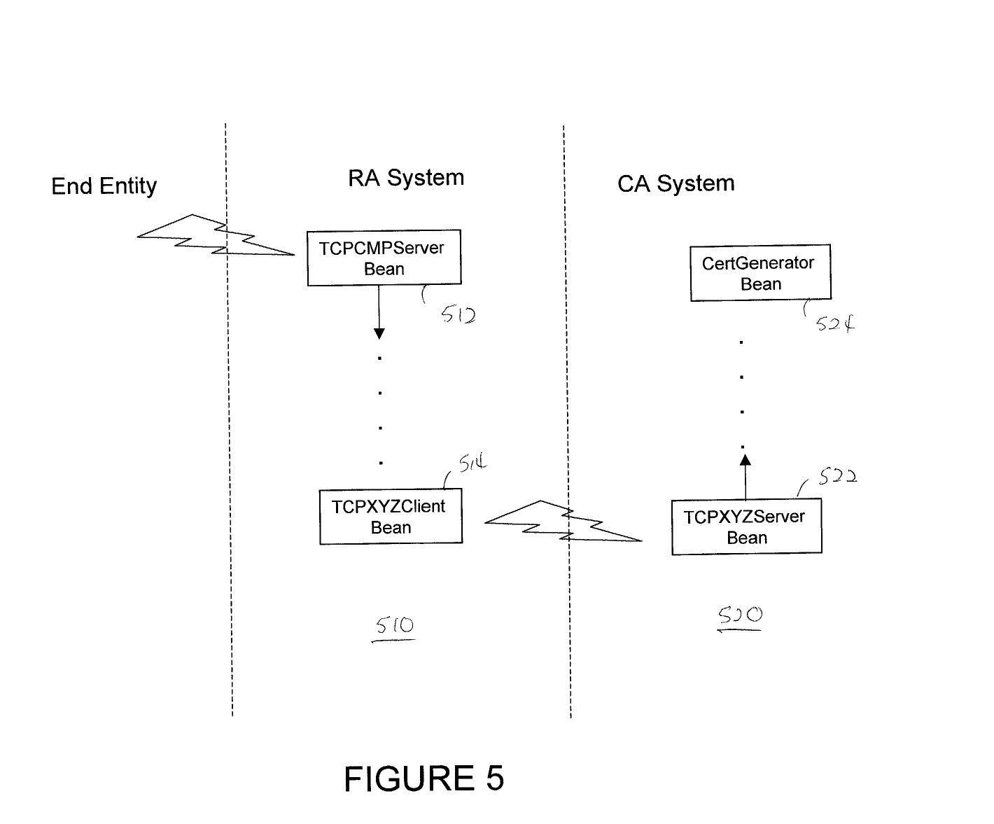

FIG. 5 is a block diagram detailing the usage of various client and server beans and the interconnectivity among the various entities across networks. An end entity (EE) promulgates a request in a CMP format across an interconnected network to an RA system 510. There, the RA system 510 receives the incoming request via a TcpCmp Server bean 512. The Server bean 512 generates an event and propagates that event through the RA system 510, wherein it is eventually directed to the CA system 520 through the TcpXyz Client bean 514 (Xyz denoting any format, including public and proprietary formats, and those formats yet to be defined).

The request generated by the TcpXyz Client bean 514 is received by the CA system 520 via a TcpXyz Server bean 522. The request is translated into an event that propagates through the CA system 520, wherein a certificate may eventually be generated by a Generator bean 524.

The resulting certificate (or other reply) is directed back through the queue-like structure of the CA system 520 and to the RA system 510, as described above. In a manner substantially similar to that described above in relation to the CA system 520, the event (and possibly the return certificate) then retreads its way back through the RA system 510, where it is eventually output back to the EE. In this manner, the various Client and Server beans allow an easily implemented interoperability among various input or output formats resulting from the use of various protocols or standards.

Additionally, the Publisher beans allow systems to dynamically adapt to changing standards and dissemination storage formats. In a similar manner, PKI systems enabled with the beans may dynamically and easily adapt to these changing standards.

Furthermore, should the certificate standards change as well, additional certificate generator beans may be defined. The generator beans may be easily placed within an already predefined system. Again, the modular aspect of the beans allows an ease of interoperability due to changes in standards or operational needs.

The same may be said for all the functional and manipulative beans as well. Finally, the filter and distributor beans allow for easy changing, designing, or adapting of PKI systems.

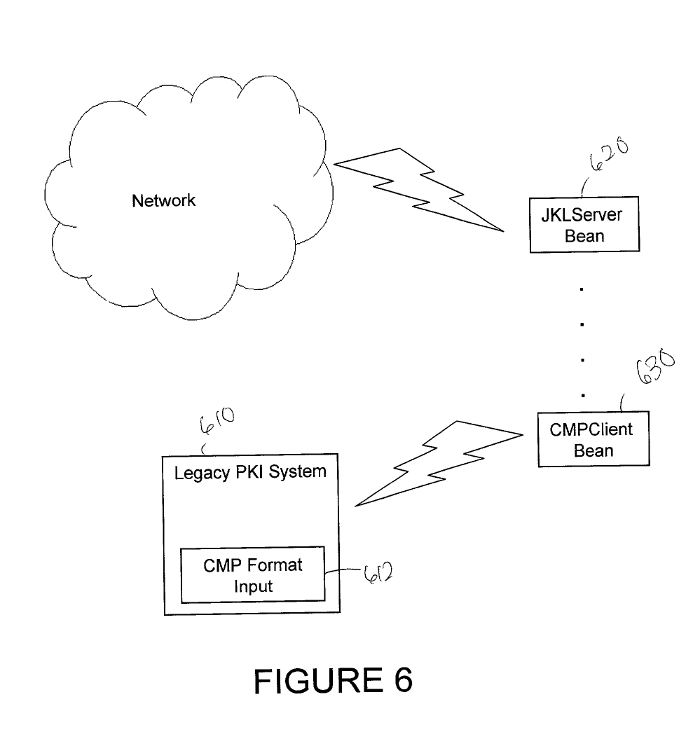

FIG. 6 is a diagram detailing the client and server beans adapting preexisting monolithic systems and providing functional expansion of these systems. A preexisting PKI system 610 contains an input 612 that only accepts CMP format requests. Assume that, for whatever reason, the operators to the system 610 wish to adapt the system 610 to accept JKL format requests. (JKL is an arbitrary designation, and can mean any presently defined public or private format related to a standard or protocol, or any other format yet to be devised.)

In this case, a JKLServer bean 620 is instantiated to accept JKL format requests. Coupled to this is one or more other beans that reformat the JKL request event initiated by the arrival of a JKL request into a CMP request event. The CMP request event is propagated to a CMPClient bean 630, which outputs a CMP format request on an output stream.

The legacy system 610 receives the CMP request and processes it in a normal manner. The CMPClient bean 630 may also be configured to receive the response back from the legacy system 610. Upon receiving the response, the beans in the adapter then renotify the users initiating the original JKL request of the status of the original request. Note that publishing functionality and granting functionality extension may also be implemented in legacy systems in a similar manner.

In this manner, the beans may provide the building blocks for additional functionality into preexisting legacy PKI systems. As such, the modular beans may also serve to extend the life and functionality of the preexisting systems.

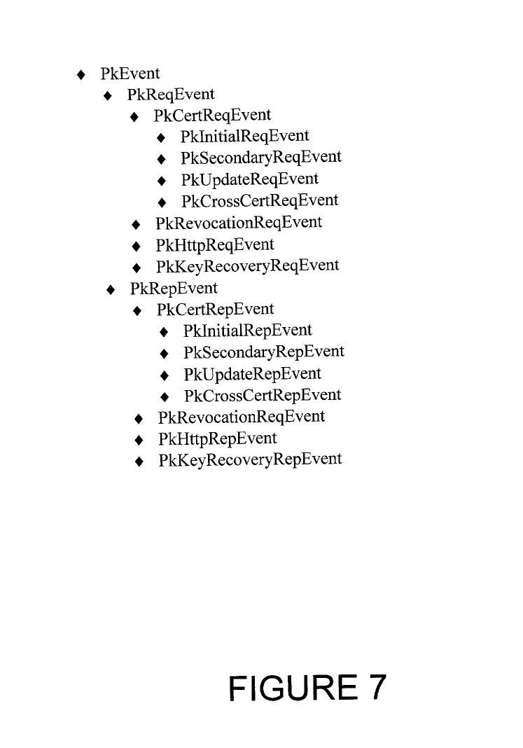

FIG. 7 is an inheritance diagram showing the particular inheritance structure of events in a particular embodiment of the invention. In this embodiment, the requests may be translated into events. There, the various possible request events are detailed as PkReqEvent (for “request”) and the classes that derive from it. Relatedly, reply events are noted as PkRepEvent (for “reply”) and serve to complete the communication structure both forward and back.

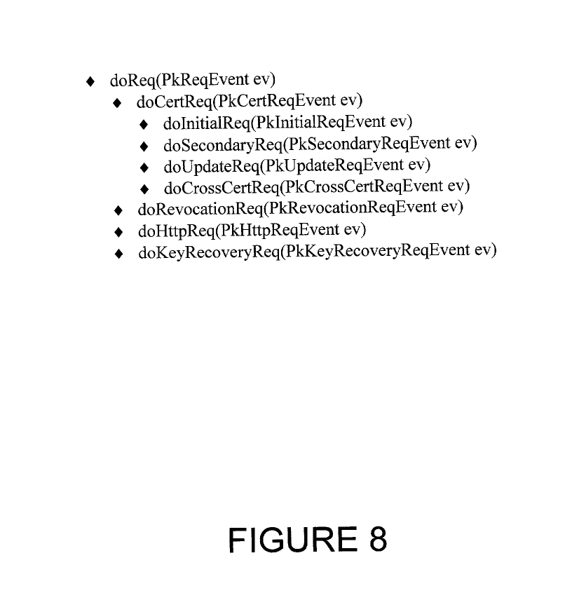

FIG. 8 is a inheritance diagram of the methods employed by the beans and using the events as noted in FIG. 7. In this embodiment, it should be noted that the particular bean implements only the methods it needs.

Now in more detail, a exemplary implementation of a specific bean is detailed with respect to the inheritance methodologies described with reference to FIGS. 7 and 8. Note particularly the returned reply events, corresponding to the request events above.

As noted before, each bean in one embodiment of the schema derives from one of three types of core beans. The three different core beans—PkSource, PkPipe and PkSink. These beans relate to the—source, sink, and throughput properties of the beans as described earlier.

In this embodiment, the following methods and calling structure are used in the bean structure.

| METHOD AND CALL | FUNCTION |
|---|---|
| PkRepEvent doreq (PkReqEvent req) | Returns the reply for a |
| | given request. This is |
| | the most general form of |
| | the request handler |
| | methods |
| PkHttpRepEvent | Returns the reply for a |
| doHttpReq(PkHttpReqEvent req) | given HTTP request |
| PkCertRepEvent | Returns the certificate |
| doPollReq(PkPollReqEvent req) | reply for a given |
| | polling request |
| PkCertRepEvent | Returns the reply for a |
| doCertReq(PkCertReqEvent req) | given general |
| | certificate request. |
| PkinitRepEvent | Returns the reply for a |
| doinitReq(PkinitReqEvent req) | given initialization |
| | request. |
| PkSecnRepEvent | Returns the reply for a |
| doSecnReq (PkSecnReqEvent req) | given secondary |
| | certificate request. |
| PkKupdRepEvent | Returns the reply for a |
| doKupdReq(PkKupdReqEvent req) | given key update |
| | request. |
| PkXcerRepEvent | Returns the reply for a |
| doXcerReg (PkXcerReqEvent req) | given |
| | cross-certification |
| | request. |
| PkKrecRepEvent | Returns the reply for a |
| doKrecReq(PkKrecReqEvent req) | given key recovery |
| | request. |
| PkRevoRepEvent | Returns the reply for a |
| doRevoReq(PkRevoReqEvent req) | given revocation |
| | request. |
| PkGnrlRepEvent | Returns the reply for a |
| doGnrlReq(PkGnrlReqEvent req) | given general request. |
| PkConfRepEvent | Returns the reply for a |
| doConfReq(PkConfReqEvent req) | given confirm request. |

Now, using PkPipe as an example, a default implementation of the above methods in a PkPipe type bean is illustrated. It should be noted that the individual beans all derive from either PkPipe, PkSource, or PkSink, and therefore would overwrite with specific methods the response that the individual bean might return. As such, the default implementation for each method is to call the method above it in the hierarchy.

Method doReq( )

Returns the reply for a given request. This is the most general form of the request handier methods, it gets called when the bean has not provided a more specific method to handle the request. The PkPipe implementation simply propagates the request event to the next listener in the chain.

public PkRepEvent doReq(PkReqEvent req) throws

PkException {

return propagate(req);

}

Method doHttpReq()

Returns the HTTP reply for a given HTTP request. The
default implementation is to simply invokes the doReq
method.
public PkHttpRepEvent doHttpReq(PkHttpReqEvent req)
throws PkException {
return (PkHttpRepEvent) propagate (req);

}

Method doCertReq

Returns the general certificate reply for a given
general certificate request. There are several
subcategories of CertReq functions, those being
dolnitreq() doSecnReq() doKupdReq(), and
doXCerReq(). The top level method implementation,
doCertReq(), simply invokes the doReq() method.
public PkCertRepEvent doCertReq(PkCertReqEvent req)
throws
PkException {
return (PkCertRepEvent)doReq(req);

}

| | |
|---|---|
| 4) | Method doInitReq() returns the initialization reply for |

a given initialization request. This implementation
simply invokes the doCertReq() method:
public PkinitRepEvent doInitReg(PkinitReqEvent req)
throws PkException { return
(PkinitRepEvent)doCertReq(req);

}

| 5) | Method doSecnReq() returns the certification reply for |
|---|---|
| | a given certification request. This implementation |
| | simply invokes the doCertReq() method. |
| | public PkSecnRepEvent doSecnReq(PkSecnReqEvent req) |
| | throws PkException { |
| | return (PkSecnRepEvent) doCertReq(req); |
| } | |
| 6) | Method PkKupdRepEvent() returns the key update reply |

for a given key update request. This implementation
simply invokes the doCertReq() method.
public PkKupdRepEvent doKupdReq(PkKupdReqEvent req)
throws PkException {

return (PkKupdRepEvent) doCertReq (req);

}

| | |
|---|---|
| 7) | Method doXcerReq() returns the cross-certificate reply |

for a given cross-certificate request. This
implementation simply invokes the doCertReq() method.
public PkXcerRepEvent doXcerReg (PkXcerReqEvent req)
throws PkException {
return (PkXcerRepEvent)doCertReq(req);

}

In order to provide a bean that handles initial certificate requests, this bean subclasses from PkPipe and overrides the doInitReq( ) method.

As another example, assume we need a bean that displays the contents of a request propagating through a chain of beans, and then displays the corresponding reply that is returned. Such a bean would subclass from PkPipe and override the doReq( ) method illustrated above.

It should be noted that the return queue may be seen as the return of reply events to the software module making the call. Upon receiving the reply event, the calling module may determine precisely what action to undertake, if any, based upon the returned reply event.

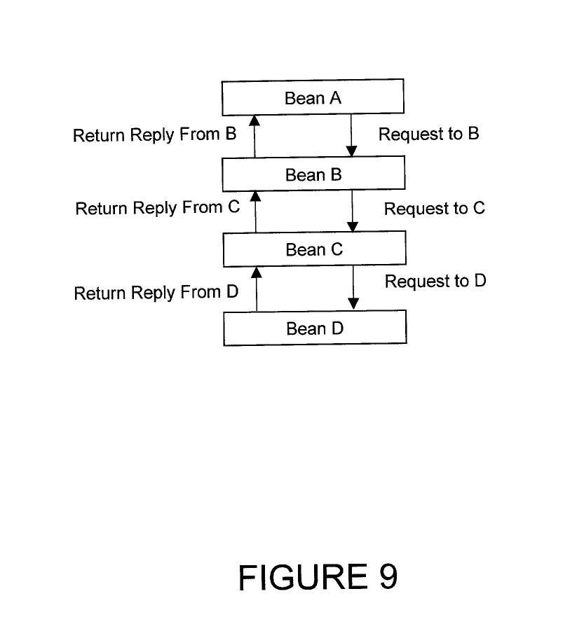

FIG. 9 is a block diagram further detailing the queue-like structure of the invention as implemented in one embodiment of the invention. Events are propagated down in the chain, just as each bean above may propagate Request events to callees. Upon completion or failure of the individual task within each module, the callee returns a Reply event to the caller.

Thus, an architecture for implementing a public key infrastructure with beans is described. It should be noted that such an architecture may be implemented with a computing device. The computing device may be a general purpose or specialized computing device. It should also be noted that the architecture may be implemented as software run on the computing device and within such components as magnetic media or computer memory associated with the computing device. Or, the architecture may be implemented in or as hardware implementations.

In view of the above detailed description of the present invention and associated drawings, other modifications and variations will now become apparent to those skilled in the art. It should also be apparent that such other modifications and variations may be effected without departing from the spirit and scope of the present invention as set forth in the claims which follow.

1. An apparatus for managing a digital certificate on a distributed computing system, the apparatus comprising:
at least one reception software module that receives a request from a user and generates a reception event corresponding to that request;
at least one processing software module, communicatively coupled to the at least one reception software module and responsive to a propagated event, that performs an action regarding the management of the digital certificate;
any one of the software modules replaceable with another software module responsive to the same propagated event but performing another action regarding the management of the digital certificate; and
the software modules executing independently from one another.

2. The apparatus of claim 1, wherein the reception software module is implemented in a computing system independent manner.

3. The apparatus of claim 2 wherein the reception software module is implemented in Java.

4. The apparatus of claim 1 wherein one of the at least one processing software modules is a sink bean.

5. The apparatus of claim 4 wherein the sink bean is a certificate generation bean.

6. The apparatus of claim 1 wherein one of the at least one processing software modules publishes information regarding the management of the certificate.

7. The apparatus of claim 6 wherein the one of the at least one software modules publishes information in an LDAP directory.

8. The apparatus of claim 1 wherein two of the software modules operate on different computing devices.

9. A computer program product on a computer usable medium, the computer usable medium having a computer usable program embodied therein for managing a digital certificate on a distributed computing system, the computer usable program including:
instructions for receiving a request from a user and generating a reception event corresponding to that request;
instructions for performing an action regarding the management of the digital certificate, the instructions for performing communicatively coupled to the instructions for receiving and responsive to a propagated event;
any one of the instructions replaceable with another set of instructions responsive to the same propagated event but performing another action regarding the management of the digital certificate; and
the instructions executing independently from one another.

10. The computer program product of claim 9, wherein the instructions for receiving are implemented in a computing system independent manner.

11. The computer program product of claim 10 wherein the instructions for receiving are implemented in Java.

12. The computer program product of claim 9 wherein instructions for performing are a sink bean.

13. The computer program product of claim 12 wherein the sink bean is a certificate generation bean.

14. The computer program product of claim 9 wherein the instructions for performing publishes information regarding the management of the certificate.

15. The computer program product of claim 14 wherein the instructions for performing publishes information in an LDAP directory.

16. The computer program product of claim 9 wherein the instructions operate on different computing devices.

17. A method for managing a digital certificate on a distributed computing system, the method comprising:
receiving a request from a user in at least one reception software module;
generating a reception event corresponding to that request;
performing an action regarding the management of the digital certificate in response to a received event in an at least one processing software module, the at least one processing software module communicatively coupled to the at least one reception software module;
any one of the software modules replaceable with another software module responsive to the same propagated event but performing another action regarding the management of the digital certificate; and
the software modules executing independently from one another.

18. The method of claim 17, wherein the reception software module is implemented in a computing system independent manner.

19. The method of claim 18 wherein the reception software module is implemented in Java.

20. The method of claim 17 wherein one of the at least one processing software modules is a sink bean.

21. The method of claim 19 further comprising generating a certificate in the bean.

22. The method of claim 19 further comprising publishing information regarding the management of the certificate in one of the at least one processing software modules.

23. The method of claim 22 step of publishing is publishing to an LDAP directory.

24. The method of claim 17 wherein two of the software modules operate on different computing devices.

25. An apparatus for managing a digital certificate on a distributed computing system, the apparatus comprising:
a plurality of reception software modules that receive a request from a user and generate a reception event corresponding to that request;
at least one processing software module, communicatively coupled to the at least one reception software module and responsive to a propagated event, that performs an action regarding the management of the digital certificate;
any one of the plurality of reception software modules replaceable with another reception software module responsive to a request in a differing format, and propagating the same event as that by the replaced reception software module; and
the software modules executing independently from one another.

26. The apparatus of claim 25, wherein the plurality of reception software modules are implemented in a computing system independent manner.

27. The apparatus of claim 26 wherein the plurality of reception software modules are implemented in Java.

28. The apparatus of claim 25 wherein one of the at least one processing software modules generates a digital certificate.

29. The apparatus of claim 25 wherein one of the at least one processing software modules publishes information regarding the management of the certificate.

30. A computer program product on a computer usable medium, the computer usable medium having a computer usable program embodied therein for managing a digital certificate on a distributed computing system, the computer usable program including:
a plurality of instructions for receiving a request from a user and generating a reception event corresponding to that request;
one or more instructions for performing an action regarding the management of the digital certificate, the instructions for performing communicatively coupled to the instructions for receiving and responsive to a propagated event;
any one of the instructions for receiving replaceable with another instruction for receiving responsive to a different format request and generating the reception event; and
the instructions executing independently from one another.

31. The computer program product of claim 30, wherein the plurality of instructions for receiving are implemented in a computing system independent manner.

32. The computer program product of claim 31 wherein the plurality of instructions for receiving are implemented in Java.

33. The computer program product of claim 30 wherein the one or more instructions for performing generates a digital certificate.

34. The computer program product of claim 30 wherein the one or more instructions for performing publishes information regarding a digital certificate.

35. A method for managing a digital certificate on a distributed computing system, the method comprising:
receiving a request in a first format from a user in one of a plurality of reception software modules;
generating a reception event corresponding to that request;
performing an action regarding the management of the digital certificate in response to a received event in an at least one processing software module, the at least one processing software module communicatively coupled to the plurality of reception software modules;
any one of plurality of reception software modules replaceable with another reception software module responsive to a request in a second format and generating the reception event; and
the software modules executing independently from one another.

36. The method of claim 35, wherein the plurality of reception software modules are implemented in a computing system independent manner.

37. The method of claim 36 wherein the plurality of reception software modules are implemented in Java.

38. The method of claim 35 further comprising generating a certificate in one of the at least one processing software module.

39. The method of claim 35 further comprising publishing information regarding the management of the certificate in one of the at least one processing software modules.

40. An apparatus for managing a digital certificate on a distributed computing system, the apparatus comprising:
at least one reception software module that receives a request from a user and generates a reception event corresponding to that request;
at least one processing software module, communicatively coupled to the at least one reception software module and responsive to a propagated event, that performs an action regarding the management of the digital certificate;
at least one transmission software module, communicatively coupled to the at least one processing software module, that transmits information regarding the digital certificate on the distributed computing system in a first format in response to a propagated event;
the at least one transmission software module replaceable with another reception software module responsive to the same event that the the replaced transmision software module is responsive to, and transmitting information in a second format; and
the software modules executing independently from one another.

41. The apparatus of claim 40, wherein the at least one reception software module and the at least one transmission software module are implemented in a computing system independent manner.

42. The apparatus of claim 41 wherein the at least one reception software module and the at least one transmission software module are implemented are implemented in Java.

43. The apparatus of claim 40 wherein one of the at least one processing software modules generates a digital certificate.

44. The apparatus of claim 40 wherein one of the at least one processing software modules publishes information regarding the management of the certificate.

45. A computer program product on a computer usable medium, the computer usable medium having a computer usable program embodied therein for managing a digital certificate on a distributed computing system, the computer usable program including:
instructions for receiving a request from a user and generating a reception event corresponding to that request;
one or more instructions for performing an action regarding the management of the digital certificate, the instructions for performing communicatively coupled to the instructions for receiving and responsive to a propagated event and generating an event;
a first instructions for transmitting information in a first format regarding the digital certificate on the distributed computing system in a first format in response to a propagated event, the instructions communicatively coupled to the at least one processing software module;
the first instructions for transmitting replaceable with a second instructions for transmitting, the second instructions for transmitting responsive to the same event that first instructions were responsive to and transmitting information regarding the digital certificate in a second format; and
the instructions executing independently from one another.

46. The computer program product of claim 45, wherein the first instructions for transmitting and the second instructions for transmitting are implemented in a computing system independent manner.

47. The computer program product of claim 46 wherein the first instructions for transmitting and the second instructions for transmitting are implemented in Java.

48. The computer program product of claim 45 wherein the one or more instructions for performing generates a digital certificate.

49. The computer program product of claim 45 wherein the one or more instructions for performing publishes information regarding a digital certificate.

50. A method for managing a digital certificate on a distributed computing system, the method comprising:
receiving a request in a first format from a user in one or more reception software modules;
generating a reception event corresponding to that request;
performing an action regarding the management of the digital certificate in response to a received event in an at least one processing software module, the at least one processing software module communicatively coupled to the plurality of reception software modules;
transmitting information regarding the digital certificate in a first format from a first transmission software module upon the reception of a propagated event;
the first transmission software module replaceable with a second transmission software module, the second transmission software module responsive to the propagated event and transmitting information regarding the digital certificate in a second format; and
the software modules executing independently from one another.

51. The method of claim 50, wherein the first transmission software module and the second transmission software module are implemented in a computing system independent manner.

52. The method of claim 51 wherein the first transmission software module and the second transmission software module are implemented in Java.

53. The method of claim 50 further comprising generating a certificate in one of the at least one processing software module.

54. The method of claim 50 further comprising publishing information regarding the management of the certificate in one of the at least one processing software modules.
